(19) United States
(12) Patent Application Publication
(10) Pub. No.: US 2023/0420855 A1
(43) Pub. Date: Dec. 28, 2023

(54) ANTENNA DEVICE

(71) Applicant: DONGWOO FINE-CHEM CO., LTD., Jeollabuk-do (KR)

(72) Inventors: Hee Jun PARK, Gyeonggi-do (KR); Ho Dong YOON, Gyeonggi-do (KR); Sung Jin HAN, Gyeonggi-do (KR)

(21) Appl. No.: 18/211,760

(22) Filed: Jun. 20, 2023

(30) Foreign Application Priority Data
Jun. 27, 2022 (KR) 10-2022-0077961

(51) Int. Cl. H01Q 9/04; H01Q 1/38; H01Q 1/50

(52) U.S. Cl. CPC H01Q 9/0471; H01Q 1/38; H01Q 1/50

(57) ABSTRACT

An antenna device according to an embodiment includes a dielectric layer, an antenna unit disposed on a top surface of the dielectric layer and including a radiator, and a dummy mesh pattern disposed around the antenna unit and spaced apart from the antenna unit. The dummy mesh pattern includes conductive lines and segmented regions at which the conductive lines are cut. The segmented regions formed in three parallel conductive lines neighboring each other among the conductive lines are not disposed together on an imaginary straight line extending perpendicularly to an extending direction of the conductive lines. A visual recognition of the antenna unit is prevented.

### PRIORITY

This application claims the benefit under 35 USC § 119 of Korean Patent Application No. 10-2022-0077961 filed on Jun. 27, 2022 in the Korean Intellectual Property Office (KIPO), the entire disclosure of which is incorporated herein by reference for all purposes.

### BACKGROUND

### 1. Field

The present invention relates to an antenna device. More particularly, the present invention relates to an antenna device including an antenna unit that includes a radiator.

### 2. Description of the Related Art

As information technologies have been developed, a wireless communication technology such as Wi-Fi, Bluetooth, etc., is combined or embedded in an image display device, an electronic device, architecture, etc.

As mobile communication technologies have been rapidly developed, an antenna capable of operating a high frequency or ultra-high frequency communication is being applied to public transportations such as a bus and a subway, a building structure, and various mobile devices.

Accordingly, the antenna may be recognized by users of mobile devices or passengers of public transportation. As a result, aesthetic properties of a structure to which the antenna is applied may be deteriorated and an image quality may also be degraded.

For example, Korean Published Patent Application No. 2019-0009232 discloses an antenna module integrated into a display panel. However, an antenna having improved radiation performance while suppressing a visual recognition is not suggested.

### SUMMARY

According to an aspect of the present invention, there is provided an antenna device having improved optical and radiation properties.

(1) An antenna device, including: a dielectric layer; an antenna unit disposed on a top surface of the dielectric layer, the antenna unit including a radiator; and a dummy mesh pattern disposed around the antenna unit and spaced apart from the antenna unit, the dummy mesh pattern including conductive lines and segmented regions at which the conductive lines are cut, wherein the segmented regions formed in three parallel conductive lines neighboring each other among the conductive lines are not disposed together on an imaginary straight line extending perpendicularly to an extending direction of the conductive lines.

(2) The antenna device according to the above (1), wherein the conductive lines include first conductive lines and second conductive lines crossing each other, and the imaginary straight line extends perpendicularly to an extending direction of the first conductive lines or an extending direction of the second conductive lines.

(3) The antenna device according to the above (2), wherein the segmented regions include first segmented regions where the first conductive lines are cut and second segmented regions where the second conductive lines are cut.

(4) The antenna device according to the above (2), wherein the dummy mesh pattern includes a plurality of a first unit cell defined by the first conductive lines and the second conductive lines neighboring each other, and the segmental regions are formed in portions except for fifth and sixth equally divisional portions when one side of the first unit cell is equally divided into 10 portions from one end to the other end.

(5) The antenna device according to the above (2), wherein the dummy mesh pattern includes a plurality of a first unit cell defined by the first conductive lines and the second conductive lines neighboring each other, and a length of each of the segmented regions is in a range from 2.5% to 6.5% of a length of one side of the first unit cell.

(6) The antenna device according to the above (5), wherein the length of each of the segmented regions is in a range from 2 μm to 5 μm.

(7) The antenna device according to the above (1), wherein the radiator includes third conductive lines and fourth conductive lines that cross each other to form a mesh structure.

(8) The antenna device according to the above (7), wherein the radiator includes a plurality of a second unit cell defined by the third conductive lines and fourth conductive lines neighboring each other, a ratio of two different diagonal lines in the second unit cell is in a range from 0.6 to 1.4.

(9) The antenna device according to the above (8), wherein lengths of the two different diagonal lines of the second unit cell are the same.

(10) The antenna device according to the above (9), wherein an insertion loss of the antenna unit is in a range from −0.18 dBi to 0 dBi.

(11) The antenna device according to the above (1), wherein the antenna unit includes a transmission line electrically connected to the radiator; and a ground pattern disposed around the transmission line and physically separated from the radiator and the transmission line.

(12) The antenna device according to the above (11), wherein the radiator includes a first radiating portion, a second radiating portion and a third radiating portion, widths of which are sequentially reduced, and the transmission line is directly connected to the third radiating portion.

(13) The antenna device according to the above (12), wherein the first radiating portion, the second radiating portion and the third radiating portion are arranged in a stepped shape.

(14) The antenna device according to the above (11), wherein the transmission line includes an inclined portion, a width of which increases in a direction toward the radiator.

(15) The antenna device according to the above (11), wherein the ground pattern includes a widened portion, a width of which increases in a direction farther from the radiator.

In example embodiments, segment regions formed in three consecutively parallel conductive lines among conductive lines included in a dummy mesh pattern may not be positioned on an imaginary straight line extending perpendicularly to an extending direction of the conductive lines. Accordingly, neighboring segmental regions in the dummy mesh pattern may be prevented from being arranged on the same line, so that the dummy mesh pattern may be prevented from being visually recognized by a user.

In some embodiments, a radiator may include a mesh structure formed by conductive lines intersecting each other. The conductive lines included in the radiator may form unit cells. A ratio of a length of one diagonal line to a length of the other diagonal line of the unit cell included in the radiator may be adjusted within a predetermined range. Accordingly, a current flow direction within the radiator may become uniform and a curvature in a current path may be reduced, thereby suppressing a signal loss.

In some embodiments, the radiator may include a plurality of radiating portions, widths of which sequentially decrease. Thus, a multi-band antenna in which a multi-band signal transmission/reception can be performed in a single radiator may be implemented.

### BRIEF DESCRIPTION OF THE DRAWINGS

FIGS. 1 and 2 are a schematic plan view and a cross-sectional view, respectively, illustrating an antenna device in accordance with exemplary embodiments.

FIG. 3 is a partially enlarged plan view of a region A in FIG. 1.

FIG. 4 is a partially enlarged plan view of a region B in FIG. 1.

FIG. 5 is a graph showing an insertion loss (S21) according to a frequency of an antenna device according to Example and Comparative Example.

FIG. 6 is a schematic diagram illustrating an application example of an antenna device in accordance with exemplary embodiments.

### DETAILED DESCRIPTION OF THE EMBODIMENTS

According to exemplary embodiments of the present invention, an antenna device including a dummy mesh pattern is provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “upper”, “lower”, “one end”, “the other end”, “top” and “bottom” used herein are intended to designate relative positions of each component, and are not intended to limit an absolute position.

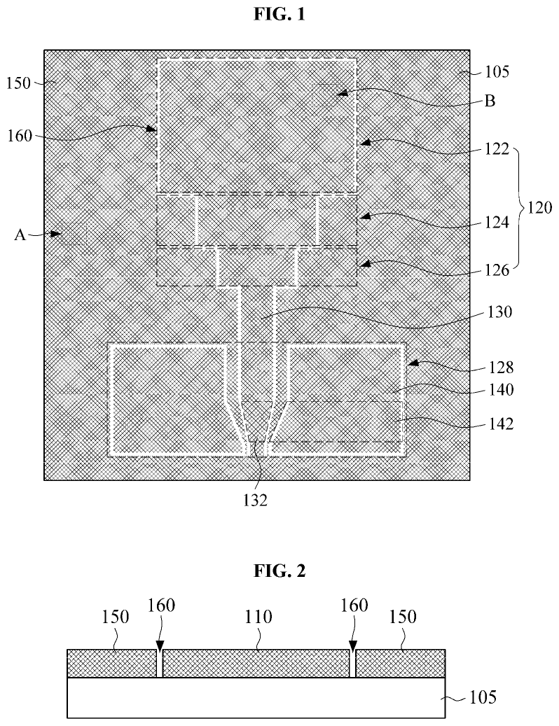

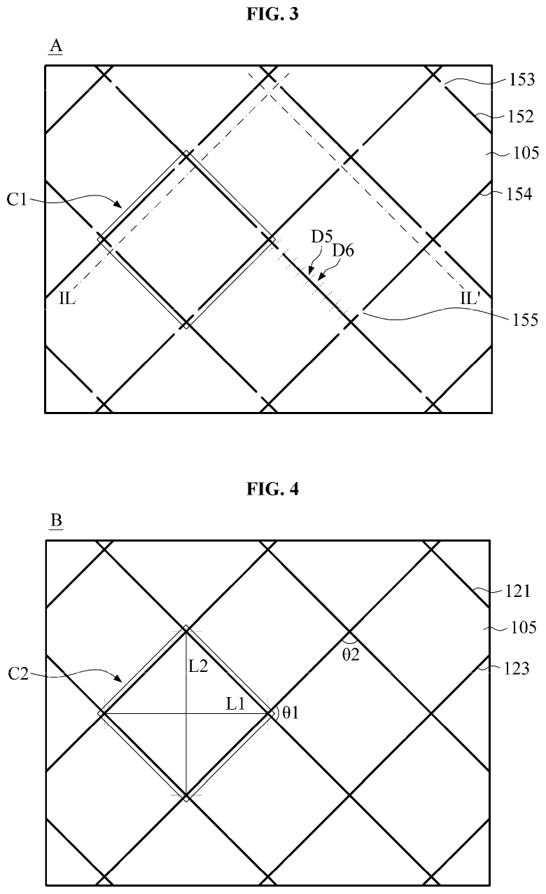

FIGS. 1 and 2 are a schematic plan view and a cross-sectional view, respectively, illustrating an antenna device in accordance with exemplary embodiments. For convenience of descriptions, illustration of detailed elements and structures of an antenna unit 110 are omitted in FIG. 2.

Referring to FIGS. 1 and 2, the antenna device may include a dielectric layer 105, an antenna unit 110 formed on the dielectric layer 105, and a dummy mesh pattern 150 spaced apart from the antenna unit 110 on the dielectric layer 105.

The dielectric layer 105 may include, e.g., a transparent resin material. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination thereof.

In some embodiments, an adhesive film such as an optically clear adhesive (OCA), an optically clear resin (OCR), etc., may be included in the dielectric layer 105.

In some embodiments, the dielectric layer 105 may include an inorganic insulating material such as glass, silicon oxide, silicon nitride, silicon oxynitride, etc.

In one embodiment, the dielectric layer 105 may be provided as a substantially single layer.

In one embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

For example, the dielectric layer 105 may include a lower dielectric layer and an upper dielectric layer. In this case, the antenna unit 110 and the dummy mesh pattern 150 may be disposed between the lower dielectric layer and the upper dielectric layer. For example, the antenna unit 110 and the dummy mesh pattern 150 may be sandwiched or buried between the lower dielectric layer and the upper dielectric layer. Accordingly, dielectric and radiation environments around the antenna unit 110 may become uniform.

In one embodiment, the upper dielectric layer may serve as a coating layer, an insulating layer and/or a protective film of the antenna unit 110 and the dummy mesh pattern 150.

Impedance or inductance for the antenna unit 110 may be generated by the dielectric layer 105, so that a frequency band at which the antenna device may be driven or operated may be adjusted. In some embodiments, a dielectric constant of the dielectric layer 105 may be adjusted in a range from about 1.5 to about 12. When the dielectric constant exceeds about 12, a driving frequency may be excessively decreased and driving in a desired high frequency band may not be implemented.

The antenna unit 110 may include a radiator 120 and a transmission line 130 electrically connected to the radiator 120. In some embodiments, the antenna unit 110 may be disposed around the transmission line 130 and may include a ground pattern 140 physically separated from the transmission line 130 and the radiator 120.

In exemplary embodiments, the radiator 120 may include a plurality of radiating portions, widths of which may be sequentially decreased. Accordingly, a multi-band antenna in which a multi-band signal transmission/reception is performed may be implemented in the single radiator

The term “width” as used herein may refer to a length of the radiator 120, the transmission line 130 or the ground pattern 140 in a horizontal direction in FIG. 1.

In some embodiments, the plurality of radiating portions may include a first radiating portion 122, a second radiating portion 124 and a third radiating portion 126, and widths of the first radiating portion 122, the second radiating portion 124 and the third radiating portion 126 may be sequentially reduced. In a plan view, the third radiating portion 126, the second radiating portion 124 and the first radiating portion 122 may be sequentially disposed from the transmission line 130.

The first radiating portion 122 may correspond to an uppermost or outermost portion in a length direction of the antenna unit 110 from the transmission line 130 in the plan view.

The first radiating portion 122 may serve as a low frequency radiator of the radiator 120 or the antenna unit 110. For example, radiation of the lowest frequency band obtained by the antenna unit 110 may be implemented from the first radiating portion 122 may be implemented. For example, a resonance frequency of the first radiating portion 122 may be in a range from about 0.1 GHz to 1.4 GHz.

In one embodiment, a radiation band corresponding to an LTE1 band may be obtained from the first radiating portion 122. In one embodiment, the resonance frequency of the first radiating portion 122 may be in a range from 0.5 GHz to 1 GHz, or from 0.6 GHz to 1 GHz.

The second radiating portion 124 may serve as a first mid-band radiator of the antenna unit 110 or the radiator 120. For example, an average resonance frequency of the second radiating portion 124 may be greater than that of the first radiating portion 122. For example, the resonance frequency of the second radiating portion 124 may be in a range from about 1.5 GHz to 2.5 GHz.

In one embodiment, a radiation band corresponding to an LTE2 band may be obtained from the second radiating portion 124. For example, the resonance frequency of the second radiating portion 124 may be in a range from 1.7 GHz to 2.0 GHz.

For example, the resonance frequency range of the second radiating portion 124 may partially overlap the resonance frequency range of the third radiating portion 126.

In some embodiments, the second radiating portion 124 may have a smaller width than that of the first radiating portion 122.

The third radiator 126 may serve as a second mid-band radiator having a higher resonance frequency range than that of the second radiator 124 of the antenna unit 110 or the radiator 120. For example, a resonance frequency of the third radiating portion 126 may be in a range from about 2.0 GHz to 3.0 GHz.

In one embodiment, a radiation band corresponding to an LTE2 band/2.4 GHz Wi-Fi band may be obtained from the third radiating portion 126. For example, the resonance frequency of the third radiating portion 126 may be in a range from about 2.2 GHz to 2.7 GHz.

For example, the resonance frequency range of the third radiating portion 126 may partially overlap the resonance frequency range of the second radiating portion 124.

In some embodiments, the third radiating portion 126 may have a smaller width than that of each of the first radiating portion 122 and the second radiating portion 124.

In some embodiments, the transmission line 130 may be directly connected to the third radiating portion 126.

The transmission line 130 may transmit, e.g., a driving signal or power from a driving integrated circuit (IC) chip to the radiator 120.

For example, one end portion of the transmission line 130 may be directly connected to the third radiating portion 126 to transmit the signal and power to the radiator 120. The other end portion of the transmission line 130 may be electrically connected to the driving IC chip through, e.g., an antenna cable. Accordingly, the signal transmission and reception, and the power supply from the driving IC chip to the radiator 120 may be performed.

In some embodiments, the transmission line 130 may include an inclined portion 132, a width of which increases in a direction from the other end portion thereof to the radiator 120. Accordingly, noises around the other end portion connected to the external circuit may be suppressed and an antenna gain can be improved.

In some embodiments, the first radiating portion 122, the second radiating portion 124 and the third radiating portion 126 may be arranged in a stepped shape. For example, a recess may be formed at a boundary between the first radiating portion 122 and the second radiating portion 124, and/or at a boundary between the second radiating portion 124 and the third radiating portion 126. Thus, independence of a driving frequency band of each radiating portion may be improved.

In some embodiments, each lateral side of the radiating portions 122, 124 and 126 may have a straight line shape. For example, each of the first radiating portion 122, the second radiating portion 124 and the third radiating portion 126 may have a rectangular shape. Accordingly, a signal transmission between the radiating portions may be implemented while suppressing impedance disturbance. Additionally, a desired frequency band may be easily adjusted.

In an embodiment, all sides of the radiator 120 may have a straight line shape.

In some embodiments, the lateral sides of the radiating portions 122, 124 and 126 may have a straight line shape parallel to the transmission line 220. Thus, a signal efficiency may be increased by reducing a distance of the signal transmission/reception.

In some embodiments, a length of the first radiating portion 122, a length of the second radiating portion 124 and a length of the third radiating portion 126 may be different from each other. Accordingly, an interval between driving frequency bands of each radiating portion may be modified based on target frequency bands.

In some embodiments, the length of the first radiating portion 122, the length of the second radiating portion 124 and the length of the third radiating portion 126 may be sequentially decreased. In this case, an interval between the driving frequency ranges of the radiating portions may become wider.

For example, a band between the driving frequency ranges of the first radiating portion 122 and the second radiating portion 124 may become wider, and a band between the driving frequency range of the second radiating portion 124 and the third radiating portion 126 may become wider. Accordingly, interference and disturbance between the driving frequency ranges may be prevented, and a resolution in each driving frequency range may be improved.

The term “length” as used herein may refer to a length in a longitudinal direction perpendicular to the horizontal direction of the radiator 120, the transmission line 130 or the ground pattern 140 in FIG. 1.

In exemplary embodiments, the ground pattern 140 may be disposed around the transmission line 130 and may be spaced apart from the radiator 120 and the transmission line 130. For example, a pair of the ground patterns 140 may be disposed to face each other with the transmission line 130 interposed therebetween.

In some embodiments, the ground pattern 140 may serve as an auxiliary radiator. For example, the ground pattern 140 may be electrically coupled to the radiator 120 and/or the transmission line 130 to serve as a fourth radiating portion 128.

The fourth radiating portion 128 may provide a high frequency radiation region of the antenna unit 110. For example, a radiation of the highest frequency band obtained by the antenna unit 110 may be implemented from the fourth radiating portion 128. For example, a resonance frequency of the fourth radiating portion 128 may be in a range from about 3.0 GHz to about 6.0 GHz.

In an embodiment, a radiation band corresponding to Sub-6 5G may be obtained from the fourth radiating portion 128. In an embodiment, a resonance frequency of the fourth radiating portion 128 may be in a range from about 3 GHz to 4 GHz or from about 3.1 GHz to 3.8 GHz.

An average resonance frequency of the fourth radiating portion 128 may be greater than that of the third radiating portion 126.

The above-described driving frequency bands of the first radiating portion 122, the second radiating portion 124, the third radiating portion 126 and the fourth radiating portion 128 are exemplary, and may be modified according to radiation properties of the antenna unit 110.

In some embodiments, the ground pattern 140 may include a widened portion 142, a width of which increases as being farther from the radiator 120 increases. For example, the width of the widened portion 142 may increase in a direction from the radiator 120 to the other end portion of the transmission line 130.

In this case, a distance between the ground pattern 140 and the transmission line 130 may decrease in the direction from the radiator 120 to the other end portion of the transmission line 130. Accordingly, a loss of a signal from the external circuit to the radiator 120 may be suppressed.

In some embodiments, a plurality of the radiators 120 may be arranged on the dielectric layer 105 to form a radiator column and/or a radiator row.

In one embodiment, two radiators 120 may be spaced apart from each other in the width direction of the dielectric layer 105 on the dielectric layer 105.

The antenna unit 110 and/or the dummy mesh pattern 150 may include silver (Ag), gold (Au), copper (Cu), aluminum (Al), platinum (Pt), palladium (Pd), chromium (Cr), titanium (Ti), tungsten (W), and niobium. (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in combination of two or more therefrom.

In an embodiment, the antenna unit 110 and/or the dummy mesh pattern 150 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the antenna unit 110 and/or the dummy mesh pattern 150 may include a transparent conductive oxide such indium tin oxide (ITO), indium zinc oxide (IZO), zinc oxide (ZnOx), indium zinc tin oxide (IZTO), etc.

In some embodiments, the antenna unit 110 and/or the dummy mesh pattern 150 may include a stacked structure of a transparent conductive oxide layer and a metal layer. For example, the antenna unit 110 and/or the dummy mesh pattern 150 may include a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The antenna unit 110 and/or the dummy mesh pattern 150 may include a blackened portion, so that a reflectance at a surface of the antenna unit 110 and/or the dummy mesh pattern 150 may be decreased to suppress a visual recognition of the antenna unit due to a light reflectance.

In an embodiment, a surface of the metal layer included in the antenna unit 110 and/or the dummy mesh pattern 150 may be converted into a metal oxide or a metal sulfide to form a blackened layer. In an embodiment, a blackened layer such as a black material coating layer or a plating layer may be formed on the antenna unit 110 and/or the dummy mesh pattern 150 or the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

As described above, the antenna device may include the dummy mesh pattern 150 disposed around the antenna unit 110 or the radiator 120. For example, the dummy mesh pattern 150 may be electrically and physically separated from the antenna unit 110 by a separation region 160.

For example, the dummy mesh pattern 150 may be formed on the dielectric layer 105 and may be formed at the same layer or the same level as that of the antenna unit 110.

For example, a conductive layer containing the metal or alloy as described above may be formed on the dielectric layer 105. A mesh structure may be formed while etching the conductive layer along a profile of the antenna unit 110 as described above. Accordingly, the antenna unit 110 and the dummy mesh pattern 150 spaced apart from each other by the separation region 160 may be formed.

FIG. 3 is a partially enlarged plan view of a region A in FIG. 1. FIG. 3 is an enlarged plan view of a partial area included in the dummy mesh pattern 150 of the antenna device according to example embodiments.

Referring to FIG. 3, the dummy mesh pattern 150 may include intersecting conductive lines 152 and 154 forming a mesh structure therein.

In example embodiments, the dummy mesh pattern 150 may include segmented regions 153 and 155 where the conductive lines 152 and 154 are cut. Accordingly, the radiation properties of the antenna unit 110 may be prevented from being disturbed by the dummy mesh pattern 150.

In a comparative example, segmented regions formed in three or more adjacent and parallel conductive lines may be disposed together on an imaginary straight line. In this case, the neighboring segmented regions are located on the same line and may be easily recognized from an outside. Accordingly, aesthetics of an object device including the antenna device may be impaired.

According to example embodiments of the present invention, the segmented regions 153 and 155 formed in three consecutive conductive lines arranged in parallel among the conductive lines 152 and 154 may not be disposed together on imaginary straight lines IL and IL′ extending perpendicularly to extension directions of the conductive lines 152 and 154.

For example, the segmented regions 153 and 155 formed on three conductive lines 152 and 154 neighboring each other may not be positioned together on the imaginary straight lines IL and IL′ extending perpendicularly to the conductive lines 152 and 154.

Thus, the adjacent segmented regions 153 and 155 of the dummy mesh pattern 150 may be prevented from being arranged on the same line to suppress the dummy mesh pattern 150 from being visually recognized by the user.

In some embodiments, the conductive lines 152 and 154 may include first conductive lines 152 and second conductive lines 154 crossing each other to form the mesh structure.

For example, the imaginary straight lines IL and IL′ may extend to be perpendicular to the extending directions of the first conductive lines 152 or the extending direction of the second conductive lines 154.

In some embodiments, the first conductive lines 152 may be cut to form first segmented regions 153, and the second conductive lines 154 may be cut to form second segmented regions 155.

For example, the first segmented regions 153 formed in three consecutive first conductive lines 152 arranged in parallel may not be located on the imaginary straight IL extending perpendicularly to the extension direction of the first conductive lines 152.

For example, the second segmented regions 155 formed in three consecutive second conductive lines 154 arranged in parallel may not be located on the imaginary straight line IL's extending perpendicularly to the extension direction of the second conductive lines 154.

In some embodiments, the dummy mesh pattern 150 may include first unit cells C1 defined by neighboring first conductive lines 152 and second conductive lines 154. For example, each of the first unit cells C1 may have a diamond shape.

In some embodiments, the segmented regions 153 and 155 may be formed in a region of a side of the unit cell C1 except for a 5th equal division region D5 and a 6th equal division region D6 when the side of the first unit cell C1 is divided into 10 equal regions from one end to the other end. For example, the segmented regions 153 and 155 may be located in regions other than a central portion of the side of the first unit cell C1 (e.g., the 5th equal division region D5 and the 6th equal division region D6).

For example, the segmented regions 153 and 155 may be formed at a position spaced apart from the one end of the side of the first unit cell C1 by 40% or less of a length of one side, preferably by 10% to 30%.

Accordingly, the segmented regions 153 and 155 may be prevented to form the imaginary straight line IL even by a minute process error, so that the dummy mesh pattern 150 may be prevented from being viewed from the outside.

In an embodiment, the segmented regions 153 and 155 may be formed at positions spaced apart from the one end of the side of the first unit cell C1 by 20% of the length of the side.

In some embodiments, the length of each of the segmented regions 153 and 155 may be from 2.5% to 6.5% of the length of the side of the first unit cell C1. Within the above length range, the segmented regions 153 and 155 may be prevented from being partially connected to cause deterioration of the antenna performance. Further, a visual recognition of the segmented regions 153 and 155 caused when sizes of the segmented regions 153 and 155 are excessively increased may also be prevented.

For example, the length of each of the segmented regions 153 and 155 may refer to a length in the extension direction of the conductive lines 152 and 154 in which each of the segmented regions 153 and 155 is formed.

In one embodiment, the length of each of the segmented regions 153 and 155 may be from 2 μm to 5 μm.

FIG. 4 is a partially enlarged plan view of a region B in FIG. 1. FIG. 4 is an enlarged plan view of a partial area included in the antenna unit 110 or the radiator 120 of the antenna device according to example embodiments.

Referring to FIG. 4, the antenna unit 110 may also share a mesh structure. Accordingly, transmittance of the antenna unit 110 may be improved. The dummy mesh pattern 150 may be distributed, so that optical properties around the antenna unit 110 may become uniform. Thus, the antenna unit 110 may be prevented from being visually recognized.

In some embodiments, the radiator 120 may include a mesh structure in which third conductive lines 121 and fourth conductive lines 123 cross each other.

In some embodiments, the radiator 120 may include second unit cells C2 defined by neighboring third and fourth conductive lines 121 and 123. For example, each of the second unit cells C2 may have a diamond shape.

In some embodiments, a ratio (L2/L1) of a length L2 of one diagonal to a length L1 of the other diagonal of the second unit cell C2 may be from 0.6 to 1.4, preferably from 0.8 to 1.2, more preferably about 1. Within the above diagonal length ratio range, a current flow path may become uniform within the radiator 120 and a curvature of the current flow path may be reduced, thereby suppressing the signal loss. Accordingly, antenna gain and signal efficiency of the antenna unit 110 may be improved.

The ratio of the lengths of the diagonal lines may be adjusted, so that an insertion loss (S21) of the antenna unit 110 may be reduced.

The term “insertion loss (S21)” used herein refers to a difference between a signal value to an input port and a signal value to an output port expressed in decibel (dBi) units.

In one embodiment, the insertion loss (S21) of the antenna unit 110 may be from −0.18 dBi to 0 dBi. Within this range, driving reliability and efficiency of the antenna unit 110 may be improved.

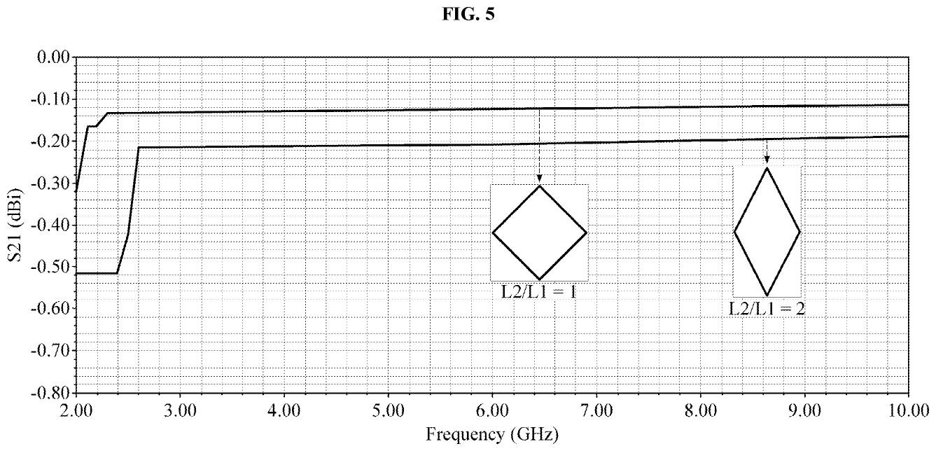

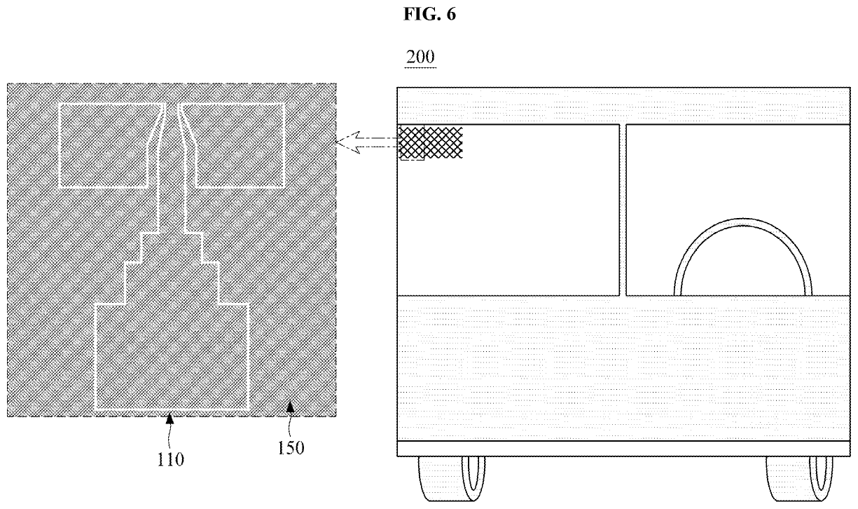

FIG. 5 is a graph showing an insertion loss (S21) according to a frequency of an antenna device according to Example and Comparative Example. FIG. 5 shows a change of the insertion loss (S21) value according to a frequency of the antenna unit having a diagonal length ratio of 1 in the second unit cell C2 and the antenna unit having a diagonal length ratio of about 2 in the second unit cell C2.

Referring to FIG. 5, the antenna unit 110 having the diagonal length ratio of 1 in the second unit cell C2 provided a reduced insertion loss S21 compared to that from the antenna unit having the diagonal length ratio of 2.

For example, the first unit cell C1 may have a diagonal length ratio in substantially the same range as that in the above-described second unit cell C2. Accordingly, the radiator 120 and the dummy mesh pattern 150 may be formed by the same patterning process to enhance process convenience.

In some embodiments, a sum of interior angles θ1 and θ2 of two different vertices in the second unit cell C2 is 180°, and each of the two interior angles θ1 and θ2 may be in a range from 60° to 120°. Preferably, each of the two interior angles θ1 and θ2 may be in a range from 80° to 100°, more preferably about 90°. In the range of the two interior angles θ1 and θ2, the signal loss suppression as described above may be substantially implemented.

In one embodiment, the antenna unit 110 may entirely have the above-described mesh structure. In one embodiment, at least a portion of the transmission line 130 and at least a portion of the ground pattern 140 may include a solid structure for a feeding efficiency.

In one embodiment, the antenna device may be applied to various objects. If the ground pattern 140 is disposed in an area of the object that is not visible to a user, the ground pattern 140 may have a solid structure.

The above-described antenna device may be applied to various structures and objects such as a window of public transportation such as a bus and a subway, a building, a vehicle, a decorative sculpture, a guidance sign (e.g., a direction sign, an emergency exit sign, an emergency light, etc.), and may serve as a relay antenna structure. The relay antenna structure may include, e.g., an access point (AP) such as a repeater, a router, a small cell, an internet router, etc.

FIG. 6 is a schematic diagram illustrating an application example of an antenna device in accordance with exemplary embodiments.

For example, FIG. 6 is a schematic diagram illustrating a router construction in which the antenna device is attached to a target object 200 (e.g., a public transportation such as a bus or subway).

Referring to FIG. 6, the antenna device may have a structure that may be fixed to a window of public transportation, a wall or a ceiling of a building structure, a window, a vehicle, a sign, etc. For example, the above-described antenna unit 110 and the dummy mesh pattern 150 may be inserted into or attached to a substrate.

For example, the substrate may serve as the dielectric layer 105 illustrated in FIG. 1. In one embodiment, the antenna unit 110 and the dummy mesh pattern 150 may be embedded in the substrate. The substrate may serve as a public transport window, a building structure, various decorative structures, an instruction sign, a window, etc.

For example, a laminate of the dielectric layer 105—the antenna unit 110 and the dummy mesh pattern 150 may be attached to the substrate or inserted into the substrate.

In some embodiments, the above-described antenna device may be attached to the substrate in the form of a film.

As described above, the dummy mesh pattern 150 including the above-described segmented regions 153 and 154 may be formed around the antenna unit 110 to suppress the antenna unit 110 from being visually recognized. At least a portion of the antenna unit 110 may also have a mesh structure.

In some embodiments, the antenna unit 110 may be connected to an external circuit board through a terminal end portion of the transmission line 130. For example, the external circuit board may be a PCB (Printed Circuit Board) including a rigid board.

For example, a conductive bonding structure such as an anisotropic conductive film (ACF) may be attached on the terminal end portion of the transmission line 130, and then a bonding area of the external circuit board may be disposed on the conductive bonding structure. Thereafter, the external circuit board may be connected to the antenna unit 110 through a heat treatment/pressing process.

An antenna cable may be electrically connected to the conductive bonding structure to supply a power to the antenna unit 110.

For example, the antenna cable may be buried in an object 200, e.g., a public transportation such as a bus or subway, an inner wall of a building, a window or a sign, etc., and may be coupled with an external power supply, an integrated circuit chip or an integrated circuit board. Accordingly, the power may be supplied to the antenna unit 110 and an antenna radiation may be performed.

As illustrated in FIG. 6, the above-described antenna unit 110 and the dummy mesh pattern 150 may be attached to the object 200 (e.g., a window of public transportation such as a bus or subway) and may be electrically connected to a Wi-Fi repeater in the public transportation through the antenna cable. Accordingly, a multi-band wireless communication network may be implemented within the public transportation.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

Conductive lines including Cu were patterned on a COP dielectric layer to form an antenna unit including second unit cells and a dummy mesh pattern including first unit cells as illustrated in FIG. 1. The conductive lines had a line width of 4.5 μm and a thickness of 0.5 μm.

Lengths of two diagonal lines of the first unit cell and the second unit cell were each 100 μm.

When the dummy mesh pattern was formed, the conductive lines were cut to form segmented regions to fabricate the antenna device. The segmented regions were formed at positions spaced apart from one end of one side of the first unit cell by 20% of the length of the one side.

The length of one side of the first unit cell and the second unit cell was about 71 μm, and each length of the segmented regions was 2.5 μm.

In the formation of the segmented regions, the patterning was performed so that the segmented regions formed on three conductive lines arranged in parallel among the conductive lines were not located together on an imaginary straight line extending perpendicularly to an extending direction of the conductive lines.

### Example 2

An antenna device was fabricated by the same method as that in Example 1, except that each of two diagonal lines of the first unit cell and the second unit cell had a length of 70 μm.

### Example 3

An antenna device was fabricated by the same method as that in Example 1, except that a length of one diagonal in the first unit cell and the second unit cell was 100 μm and a length of the other diagonal line was 200 μm.

### Comparative Example 1

An antenna device was fabricated by the same method as that in Example 1, except that the segmented regions were formed at positions spaced apart from one end of one side of the first unit cell by 50% of the length of the one side.

It was observed that the segmented regions formed on three conductive lines arranged in parallel were located together on the imaginary straight line.

### Comparative Example 2

An antenna device was fabricated by the same method as that in Comparative Example 1, except that the segmented regions were randomly formed at random positions in the first unit cells.

### Comparative Example 3

An antenna device was fabricated by the same method as that in Comparative Example 1, except that the length of one diagonal line in the first unit cell and the second unit cell was 100 μm and the length of the other diagonal line was 200 μm.

### Comparative Example 4

An antenna device was fabricated by the same method as that in Comparative Example 1, except for the details of i) and ii) below.

i) The length of one diagonal line in the first unit cell and the second unit cell was 100 μm, and the length of the other diagonal line was 200 μm

ii) The segmented regions were randomly formed at random locations in the first unit cells.

Experimental Example

(1) Evaluation on Visual Recognition

A sample having a size of 1 mm×1 mm from the dummy mesh pattern region in the antenna device according to each of Examples and Comparative Examples was prepared. The sample was attached under a glass substrate and visually observed.

<Evaluation Criteria>
◯: Not recognized
Δ: Visually recognized in 1 to 10 portions
X: recognized in 11 or more portions

(2) Insertion Loss (S21)

An insertion loss (S21) of each antenna device according to Examples and Comparative Examples was measured using a HFSS simulator (Ansys Co.).

The diagonal length of the unit cell, the position of the segmented region, the visibility evaluation result and the insertion loss (S21) value of Examples and Comparative Examples are shown in Table 1 below.

In Table 1, the position of the segmented region is a distance from one end of one side of the first unit cell, and the distance is expressed as a percentage of the length of one side.

TABLE 1

| | diagonal | position of | | insertion |
|---|---|---|---|---|
| | length of | segmented region | visibility | loss (S21) |
| No. | unit cell (μm) | (%) | evaluation | (dBi) |
| Example 1 | 100*100 | 20 | ◯ | −0.15 |
| Example 2 | 70*70 | 20 | ◯ | −0.12 |
| Example 3 | 100*200 | 20 | ◯ | −0.24 |
| Comparative | 100*100 | 50 | X | −0.15 |
| Example 1 | | | | |
| Comparative | 100*100 | random | Δ | −0.16 |
| Example 2 | | | | |
| Comparative | 100*200 | 50 | X | −0.24 |
| Example 3 | | | | |
| Comparative | 100*200 | random | Δ | −0.21 |
| Example 4 | | | | |

Referring to Table 1, in Examples 1 to 3 where the segmented regions formed on the three conductive lines arranged in parallel were not located together on the imaginary straight line extending perpendicularly to the extension direction of the conductive lines, the visual recognition from an outside was suppressed compared to those from Comparative Examples.

In Comparative Examples 2 and 4 where the segmented regions were formed at random positions, the segmented regions were arranged on the imaginary straight line in some portions and were visually recognized from the outside.

In Example 3 and Comparative Examples 3 and 4 where the ratio of the diagonal lengths of the unit cell was 2, the insertion loss (S21) was relatively increased compared to those from other Examples.

What is claimed is:

1. An antenna device comprising:
a dielectric layer;
an antenna unit disposed on a top surface of the dielectric layer, the antenna unit comprising a radiator; and
a dummy mesh pattern disposed around the antenna unit and spaced apart from the antenna unit, the dummy mesh pattern comprising conductive lines and segmented regions at which the conductive lines are cut, wherein the segmented regions formed in three parallel conductive lines neighboring each other among the conductive lines are not disposed together on an imaginary straight line extending perpendicularly to an extending direction of the conductive lines.

2. The antenna device according to claim 1, wherein the conductive lines comprise first conductive lines and second conductive lines crossing each other, and
the imaginary straight line extends perpendicularly to an extending direction of the first conductive lines or an extending direction of the second conductive lines.

3. The antenna device according to claim 2, wherein the segmented regions comprise first segmented regions where the first conductive lines are cut and second segmented regions where the second conductive lines are cut.

4. The antenna device according to claim 2, wherein the dummy mesh pattern comprises a plurality of a first unit cell defined by the first conductive lines and the second conductive lines neighboring each other, and
the segmental regions are formed in portions except for fifth and sixth equally divisional portions when one side of the first unit cell is equally divided into 10 portions from one end to the other end.

5. The antenna device according to claim 2, wherein the dummy mesh pattern comprises a plurality of a first unit cell defined by the first conductive lines and the second conductive lines neighboring each other, and
a length of each of the segmented regions is in a range from 2.5% to 6.5% of a length of one side of the first unit cell.

6. The antenna device according to claim 5, wherein the length of each of the segmented regions is in a range from 2 μm to 5 μm.

7. The antenna device according to claim 1, wherein the radiator comprises third conductive lines and fourth conductive lines that cross each other to form a mesh structure.

8. The antenna device according to claim 7, wherein the radiator comprises a plurality of a second unit cell defined by the third conductive lines and fourth conductive lines neighboring each other, and
a ratio of two different diagonal lines in the second unit cell is in a range from 0.6 to 1.4.

9. The antenna device according to claim 8, wherein lengths of the two different diagonal lines of the second unit cell are the same.

10. The antenna device according to claim 9, wherein an insertion loss of the antenna unit is in a range from −0.18 dBi to 0 dBi.

11. The antenna device according to claim 1, wherein the antenna unit comprises:
a transmission line electrically connected to the radiator; and
a ground pattern disposed around the transmission line and physically separated from the radiator and the transmission line.

12. The antenna device according to claim 11, wherein the radiator comprises a first radiating portion, a second radiating portion and a third radiating portion, widths of which are sequentially reduced, and
the transmission line is directly connected to the third radiating portion.

13. The antenna device according to claim 12, wherein the first radiating portion, the second radiating portion and the third radiating portion are arranged in a stepped shape.

14. The antenna device according to claim 11, wherein the transmission line comprises an inclined portion, a width of which increases in a direction toward the radiator.

15. The antenna device according to claim 11, wherein the ground pattern comprises a widened portion, a width of which increases in a direction farther from the radiator.
